(19) United States
(12) Patent Application Publication
(10) Pub. No.: US 2011/0045214 A1
(43) Pub. Date: Feb. 24, 2011

(54) CLEANING PASTE

(75) Inventors: Eckhard Ernst, Pulheim (DE); Heinz Jeschek, Wolfen (DE)

Correspondence Address: VENABLE LLP, P.O. BOX 34385, WASHINGTON, DC, 20043-9998, US

(73) Assignee: Pasta Clean Gmbh, Pulheim (DE)

(21) Appl. No.: 12/742,510

(22) PCT Filed: Nov. 12, 2007
(86) PCT No.: PCT/EP2007/062197

§ 371 Date: Aug. 19, 2010

(51) Int. Cl. C11D 7/60; B32B 1/08

(52) U.S. Cl. 428/34.1; 510/275; 510/244; 510/245; 510/281; 510/278

(57) ABSTRACT

A cleaning paste containing

from 35 to 45% by weight of one or more naphtha fractions;

from 15 to 25% by weight of oleoylmethyltaurine or a salt thereof;

from 5 to 20% by weight of ethoxylated fatty alcohols;

from 15 to 25% by weight of alkali dithionite.

The present invention relates to a cleaning paste, a process for the preparation thereof, and the use thereof.

A wide variety of kinds of cleaning agents have been known for centuries. In the simplest case, these may be soap powder or similar agents.

Also on the market are a variety of specialty products offered for stain removal, in part adapted to very special stain compositions, such as ketchup, chewing gum, red wine etc. It is disadvantageous in this case that the exact origin of a stain must be known, which is not always the case.

In addition, there are in part very aggressive cleaning agents which may also attack the material to be cleaned, especially for colored materials, and additionally may require that the user wears protective clothing.

Therefore, there is a further need for cleaning agents that can be used universally if possible and that combine a high cleaning performance with an acceptable skin tolerability.

Surprisingly, this object could be achieved by a cleaning paste containing
from 35 to 45% by weight of one or more naphtha fractions;
from 15 to 25% by weight of oleoylmethyltaurine or a salt thereof;
from 5 to 20% by weight of ethoxylated fatty alcohols;
from 15 to 25% by weight of an alkali dithionite.

On the one hand, the cleaning paste according to the invention contains from 35 to 45% by weight of one or more naphtha fractions. Preferably, those naphtha fractions having boiling ranges of above 180° C. are employed. For example, solvent naphthas sold under the designation of Testbenzin 180/210 are suitable. Their boiling range is from 180 to 210° C.

Another component is oleoylmethyltaurine or a salt thereof, preferably a salt as sold, for example, as Hostapon® TPHC (sodium oleoylmethyltauride).

Another component is ethoxylated fatty alcohols, preferably having predominantly from 16 to 18 carbon atoms. Such fatty alcohols are sold, for example, under the designation EMULDAC® AS 25.

Further, according to the invention, an alkali dithionite is to be used, preferably sodium dithionite.

In addition, the paste may contain further surfactants, preferably in an amount of from 0.5 to 5% by weight. Such surfactants may preferably be anionic or non-ionic. Suitable substances are sold, for example, under the designations of Sokalan® or Präwozell®.

In addition, the paste may contain inorganic salts. Suitable amounts are within a range of up to 10% by weight. These may be, for example, phosphates and sulfates. For example, suitable substances include sodium triphosphates and sodium sulfates.

In a preferred embodiment, the cleaning paste contains one or more perfumes.

In a preferred embodiment, the content of naphtha fractions is within a range of from 40 to 42% by weight, and the content of oleoylmethyltaurine or salts thereof is within a range of from 18 to 22% by weight. Preferably, the content of the ethoxylated fatty alcohols is within a range of from 5 to 10% by weight, and the content of alkali dithionite is within a range of from 17 to 21% by weight, wherein the balance to 100 can be completed with the further auxiliary agents.

The mixture according to the invention is a paste. Pastes are liquids having a pasty consistency. For the definition of a paste, reference can be made to the definition of DE 102 05 134 A1. Of course, the composition according to the invention may contain further components.

Surprisingly, in addition to an excellent cleaning performance, especially for stains from, for example, fruits, iodine, ink, grease etc., the cleaning paste according to the invention exhibits a good skin tolerance in dermatological tests into the bargain.

For an open epicutaneous test, 20 subjects aged 23-62 years having a healthy skin were selected. The product was applied at a concentration of 10% in water on an area of about 3 cm in diameter on the forearm for a testing period of ten minutes. Thereafter, the parameters erythema, fissure and scaling were read, and the subjects were asked about subjective sensations, such as burning, itching or other unpleasant sensations.

Within the scope of this test, the tested product did not show any effects (neither objective nor subjective ones), so that it may be characterized as non-irritant in consideration of the Labeling Regulation by analogy with the evaluation of dish-washing detergents.

The invention also relates to a process for the preparation of the cleaning paste, comprising the step of mixing
from 35 to 45% by weight of one or more naphtha fractions;
from 15 to 25% by weight of oleoylmethyltaurine or a salt thereof;
from 5 to 20% by weight of ethoxylated fatty alcohols;
from 15 to 25% by weight of an alkali dithionite;

and to the use of the paste according to the invention for removing stains, for example, from clothes, carpets etc.

The invention also relates to a collapsible metal tube containing the cleaning paste according to the invention.

1. A cleaning paste containing
from 35 to 45% by weight of one or more naphtha franctions;
from 15 to 25% by weight of oleoylmethyltaurine or a salt thereof;
from 5 to 20% by weight of ethoxylated fatty alcohols;
from 15 to 25% by weight of alkali dithionite.

2. The cleaning paste according to claim 1, further containing from 0.5 to 5% by weight of surfactants.

3. The cleaning paste according to claim 1, further containing up to 10% by weight of inorganic salts.

4. The cleaning paste according to claim 1, additionally containing perfumes.

5. The cleaning paste according to claim 1, wherein the naphtha fractions have a boiling range of above 180° C.

6. The cleaning paste according to claim 1, wherein said ethoxylated fatty alcohols are C₁₆ to C₁₈ fatty alcohols.

7. The cleaning paste according to claim 2, wherein said further contained surfactants are anionic surfactants or non-ionic surfactants.

8. A process for the preparation of a cleaning paste, comprising the step of mixing
from 35 to 45% by weight of one or more naphtha fractions;
from 15 to 25% by weight of oleoylmethyltaurine or a salt thereof;
from 5 to 20% by weight of ethoxylated fatty alcohols;
from 15 to 25% by weight of alkali dithionite.

9. Use of a cleaning paste according to claim 1 for cleaning leather, plastics, metal and textiles, especially for removing stains from carpets, furniture, clothing or jewelry.

10. A collapsible metal tube containing a cleaning paste according to claim 1.
